(19) United States
(12) Patent Application Publication
(10) Pub. No.: US 2016/0339555 A1
(43) Pub. Date: Nov. 24, 2016

(54) APPARATUS FOR REMOVING WASTE MATERIAL FROM FLUTES OF A ROTATING HOB WHEN PRODUCING GEARS

(71) Applicant: Caterpillar Inc., Peoria, IL (US)

(72) Inventors: Gabriel J Ellicott, Peoria Heights, IL (US); Daniel Kief Stein, Dunlap, IL (US)

(73) Assignee: Caterpillar Inc., Peoria, IL (US)

(21) Appl. No.: 14/714,447

(22) Filed: May 18, 2015

(51) Int. Cl. B23Q 11/02; B23F 9/08; B23F 23/12

(52) U.S. Cl. CPC B23Q 11/02; B23F 23/12; B23F 9/082

(57) ABSTRACT

An apparatus for removing waste material from flutes of a rotating hob includes an elongated handle disposed alongside the hob; and a brush wheel disposed at a first end of the handle. The brush wheel includes bristles that are disposed in abutment with at least one flute of the hob.

### TECHNICAL FIELD

The present disclosure relates to an apparatus for removing waste material from a machining tool during a machining process, and more particularly, to an apparatus for removing waste material from flutes of a rotating hob when producing gears.

### BACKGROUND

Machine tools such as for e.g., drill bits, gear hobs and the like typically include flutes that are prone to accumulating waste material when executing a machining operation on a part. The waste material may be, for e.g., metal chips and such waste material can get deposited on the tool as the tool is machining the part. These metal chips can then get trapped between the tool and the part as the tool undergoes subsequent motion during operation. Therefore, such waste material can potentially deteriorate an overall quality or finish of the part formed by the tool. In order to improve a quality of parts formed by the tool, these metal chips may need to be removed as soon as they are deposited in and around the tool, for e.g., in the flutes of a gear hob.

For reference, U.S. Pat. No. 5,421,680 relates to a device for preventing a drilling chip from winding around a drill bit and for removing the drilling chip deposited in flutes of the drill bit. The drill bit is configured to act as a driving member while a driven gear having at least one tooth engageable with flutes of the drill bit is provided. As the drill bit is turned to drill a hole, the driven gear is actuated to turn such that the tooth of the driven gear engages the flute of the drill bit. This way, any drilling chips deposited in the flute of the drill bit may be scraped off and prevented from winding around the drill bit in action. The driven gear is rotatably and movably fastened to a support rod which is in turn can be fastened to a drill press.

### SUMMARY OF THE DISCLOSURE

In an aspect of the present disclosure, an apparatus is provided for removing waste material from flutes of a rotating hob when producing gears. The apparatus includes an elongated handle disposed alongside the hob; and a brush wheel disposed at a first end of the handle. The brush wheel includes bristles that are disposed in abutment with at least one flute of the hob. In various aspects of the present disclosure, the bristles of the brush wheel could be formed or made from at least one of plastic, metal, and fabric

In one aspect of the present disclosure, the brush wheel can be formed to such that a profile of the brush wheel is helical. However, the brush wheel can optionally be formed to have other profiles such as, but not limited to, cylindrical, circular, rounded, bell-shaped, and hourglass-shaped.

Moreover, a longitudinal axis of the brush can be disposed at an angle of about 0 to 90 degrees with respect to a longitudinal axis of the hob. Further, a distance between the longitudinal axes of the brush wheel and the hob can be adjusted to suit various requirements of a specific machining application.

Furthermore, the brush wheel can be configured to remain stationary with respect to the rotating hob. However, the brush wheel can alternatively be configured to rotate with respect to the rotating hob. Moreover, the brush wheel can optionally be configured to rotate synchronously with the hob.

In another aspect of the present disclosure, the elongated handle can be configured to remain stationary with respect to the rotating hob such that the brush wheel remains stationary with respect to the rotating hob. Optionally, a second end of the elongated handle could be configured to rotatably connect with a drive mechanism associated with the hob and any rotation of the elongated handle by the drive mechanism can cause the brush wheel to rotate in relation to the hob. Alternatively, the apparatus can be configured to further include a prime mover that can be coupled with the second end of the elongated handle. This prime mover can be configured to operatively rotate the elongated handle and the brush wheel with respect to the rotating hob.

Additionally or optionally, a length of the brush wheel measured along the longitudinal axis of the brush wheel can be lesser than a length of the hob measured along the longitudinal axis of the hob. In such case, the brush wheel can be additionally configured to travel along the length of the hob in an axis parallel to the longitudinal axis of the hob. Moreover, if the length of the brush wheel is similar to the length of the hob, then brush wheel could also be configured to travel synchronously with the hob when the hob undergoes translatory motion.

In yet another aspect of the present disclosure, a method for removing waste material from flutes of a rotating hob includes providing a brush wheel having a plurality of bristles, and positioning the brush wheel adjacent to the hob such that the bristles are disposed in abutment with at least one flute of the hob. Moreover, the method could include forming the brush wheel such that a profile of the brush wheel is at least one of: a cylindrical shape, a circular shape, a helical shape, a rounded shape, a bell-shape, and an hourglass-shape.

Optionally, the method could include providing an elongated handle having a first end and a second end, wherein the first end is configured to support the brush wheel thereon, and wherein the second end is configured to rotatably connect with a drive mechanism associated with the hob.

In another aspect, the method could include configuring the brush wheel to travel along the length of the hob in an axis parallel to the longitudinal axis of the hob. However, if the length of the brush wheel is similar to the length of the hob, the method could additionally include configuring the brush wheel to travel synchronously with the hob when the hob undergoes translatory motion.

Other features and aspects of this disclosure will be apparent from the following description and the accompanying drawings.

### BRIEF DESCRIPTION OF THE DRAWINGS

FIG. 1 is a perspective view of an exemplary hob on which embodiments of the present disclosure can be implemented, the hob being shown in state of operation for producing a gear;

FIG. 2 is a front view of an apparatus employed to remove waste material from flutes of the hob, in accordance with an embodiment of the present disclosure;

FIG. 3 is a front view of the apparatus, in accordance with another embodiment of the present disclosure;

FIG. 4 is a front view of the apparatus, in accordance with another embodiment of the present disclosure;

FIGS. 5-6 are front and side views of the apparatus respectively, in accordance with another embodiment of the present disclosure;

FIG. 7-9 are front views of the apparatus, in accordance with other embodiments of the present disclosure; and

FIG. 10 is a method of removing waste materials from flutes of the hob, in accordance with an embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

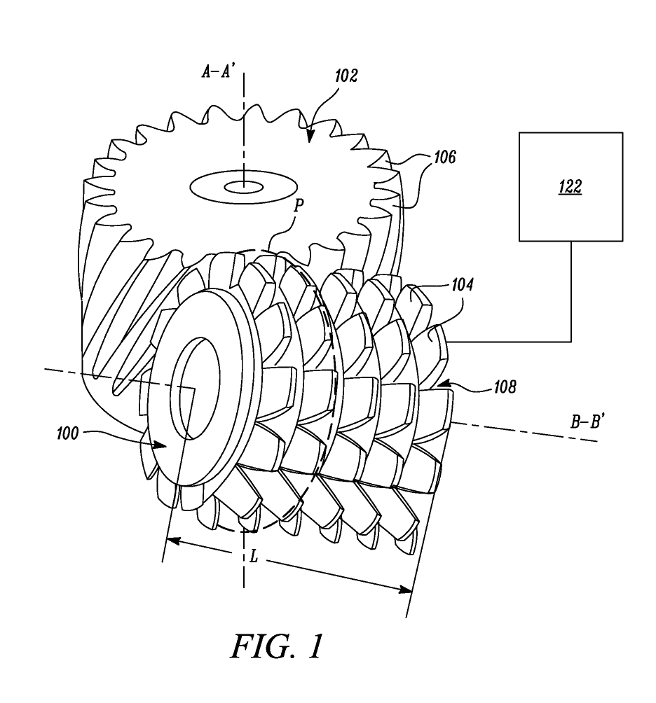

FIG. 1 shows a perspective view of an exemplary hob 100 on which embodiments of the present disclosure can be implemented, the hob 100 being shown in state of operation on a metal blank 102 for producing a gear (hereinafter denoted with same reference numeral ‘102’). The gear 102, as shown in the illustrated embodiment of FIG. 1, is a partially-formed helical gear. However, any type of gear such as, but not limited to, spur gears, bevel gears, double-helical gears, spiral gears, and worms may be produced by the hob 100 in place of the helically cut gear 102 disclosed herein. A person of ordinary skill in the art will appreciate that embodiments of the present disclosure can be beneficially implemented in various other types of hobs commonly known in the art without deviating from the spirit of the present disclosure. Some examples of hobs which are commonly known to one skilled in the art are, but is not limited to, worm wheel hobs, spline hobs, chamfer hobs, a spur and helical gear hob (as shown in FIG. 1), straight side spline hobs, involute spline hobs, serration hobs, and semi-topping gear hobs.

Referring to FIG. 1, the hob 100 includes multiple cutting teeth 104 (hereinafter simply referred to as ‘teeth’ and designated with identical numeral ‘104’). These teeth 104 can be rotated against the metal blank 102 to rotatively produce teeth 106 on the metal blank 102 and thus form the gear 102. In the illustrated embodiment of FIG. 1, the teeth 106 on the gear 102 are shown to extend laterally away and are disposed about a longitudinal axis A-A′ of the gear 102. However, these teeth 106 may be oriented in any manner relative to the longitudinal axis A-A′ of the gear 102 depending on a type of gear that is being produced using the hob 100.

Moreover, as shown in the illustrated embodiment of FIG. 1, the teeth 104 on the hob 100 are spirally arranged and disposed laterally away from a longitudinal axis B-B′ of the hob 100. Further, as shown in FIG. 1, the teeth 104 of the hob 100 are spaced away from one another to define flutes 108 therebetween. These flutes 108 may be configured to beneficially remove waste material, for e.g. metal chips, that is typically produced during machining of the gear 102. However, as commonly known to one skilled in the art, this waste material also has some propensity for deposition at the flutes 108 thereby altering various cutting depths of the hob 100. This deposited waste material may get trapped in the respective flutes 108 of the hob 100 when the hob 100 executes subsequent motion (i.e., rotation about its longitudinal axis B-B′) to form teeth 106 on the metal blank 102 (i.e., partially formed gear 102). Therefore, deposition of waste material in the flutes 108 of the hob 100 can lead to a potential deterioration in the quality and overall finish of the gear 102 formed using the hob 100.

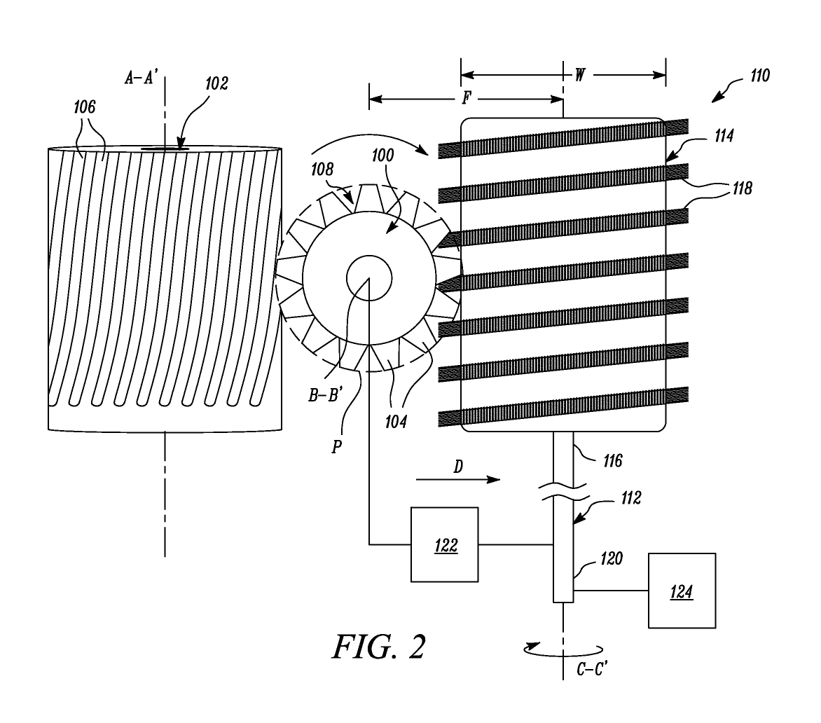

The present disclosure relates to an apparatus 110 for removing waste material from the flutes 108 of the hob 100 when the hob 100 is rotatively cutting teeth 106 on the metal blank 102 for producing the gear 102. Referring to FIG. 2, the apparatus 110 includes an elongated handle 112 disposed alongside the hob 100; and a brush wheel 114 disposed at a first end 116 of the handle 112. The brush wheel 114 includes bristles 118 that are disposed in abutment with at least one flute of the hob 100.

In the illustrated embodiment of FIG. 2, the brush wheel 114 has a helical profile i.e., the bristles 118 are formed in a helical configuration. The bristles 118 of the brush wheel 114 shown in FIG. 2 are helically arranged so as to accomplish contact with at least two flutes 108 of the hob 100 at a given instant of time. However, in alternative embodiments, a profile of the brush wheel 114 (represented by the bristles 118 present thereon) can be changed to allow contact of the bristles 118 with any number of flutes 108 depending on specific requirements of a machining application. For example, the brush wheel 114 can optionally be formed to have other profiles such as, but not limited to, cylindrical, circular, rounded, bell-shaped, and hourglass-shaped depending on specific requirements of an application. Explanation pertaining to different configurations, shapes and/or profiles of the brush wheel 114 will be made later in this document.

In an embodiment of the present disclosure, these bristles 118 are formed from a suitable plastic material. However, in alternative embodiments, the bristles 118 could, optionally or additionally, be formed from metal or fabric. It is hereby envisioned that the bristles 118 are beneficially made from a ‘soft’ material to avoid any inadvertent damage to the teeth 104 on the hob 100. More specifically, it is hereby contemplated to form the bristles 118 from a material whose hardness is substantially lesser than a hardness exhibited by the material of the hob 100.

In the illustrated embodiment of FIG. 2, the brush wheel 114 is in contact with the hob 100 in a direction D opposite to that in which the gear 102 makes contact with the hob 100. Moreover, in this embodiment, a longitudinal axis C-C′ of the brush wheel 114 is disposed at an angle θ of 90 degrees with respect to the longitudinal axis B-B′ of the hob 100. However, the brush wheel 114 can be positioned such that its longitudinal axis subtends any angle θ between 0 and 90 degrees with respect to the longitudinal axis B-B′ of the hob 100. Further, a distance F between the longitudinal axes C-C′, B-B′ i.e., of the brush wheel 114 and the hob 100 can be adjusted to suit various requirements of a specific machining application for e.g., to vary a force of contact between the bristles 118 of the brush wheel 114 and the flutes 108 of the hob 100. Therefore, it may be noted that the arrangement of the brush wheel 114 relative to the hob 100, disclosed in FIG. 2, is merely exemplary in nature and hence, non-limiting of this disclosure. It can be beneficially contemplated by one skilled in the art to position the brush wheel 114 at other points along a periphery of the hob 100 such that a contact is accomplished between the bristles 118 of the brush wheel 114 and the flutes 108 of the hob 100 without deviating from the spirit of the present disclosure. Some alternate positional arrangements of the brush wheel 114 in relation to the hob 100 will be discussed later in this document.

In an embodiment of the present disclosure, the brush wheel 114 can be configured to remain stationary with respect to the rotating hob 100. In this embodiment, the brush wheel 114 can be rigidly connected to the first end 116 of the handle 112 such that the brush wheel 114 and the handle 112 are unitary in construction. This way, when the handle 112 is stationary with respect to the hob 100, the brush wheel 114 also remains stationary.

However, in another embodiment as shown in FIG. 2, it can be optionally contemplated to rotate the brush wheel 114 against the rotating hob 100. In this embodiment, a second end 120 of the elongated handle 112 could be configured to rotatably connect with a drive mechanism 122 associated with the hob 100. In this manner, the brush wheel 114 can be configured to rotate with respect to the rotating hob 100. Further, the brush wheel 114 can, additionally or optionally, be configured to rotate synchronously with the hob 100 i.e., at a similar or different speed in relation to a rotational speed of the hob 100.

For example, if the hob 100 rotates at a speed of 450 revolutions per minute (rpm), the brush wheel 114 can also be configured to rotate at similar speed i.e., 450 rpm, or at a speed that is lesser or more than 450 rpm, say, at a speed of 200 rpm, or at another speed of 900 rpm. It can hereby be contemplated by persons skilled in the art to cause a variation in the rotational speed of the brush wheel 114 by implementing suitable mechanisms, for e.g., gearing mechanisms between the second end 120 of the elongated handle 112 and the drive mechanism 122.

In an alternative embodiment as shown in FIG. 2, the apparatus 110 can be configured to optionally include a prime mover 124 so as to cause rotation of the brush wheel 114 in relation to the rotating hob 100. This prime mover 124 can be for e.g., an electric motor, but is not limited thereto. Various other types of prime movers known in the art can be implemented in lieu of the electric motor disclosed herein. Moreover, it will be appreciated that the prime mover 124, disclosed herein, can be beneficially configured to vary a rotational speed of the brush wheel 114 so as to allow a step-down (decrease) or increase in the rotational speed of the brush wheel 114 in relation to a rotational speed of the hob 100.

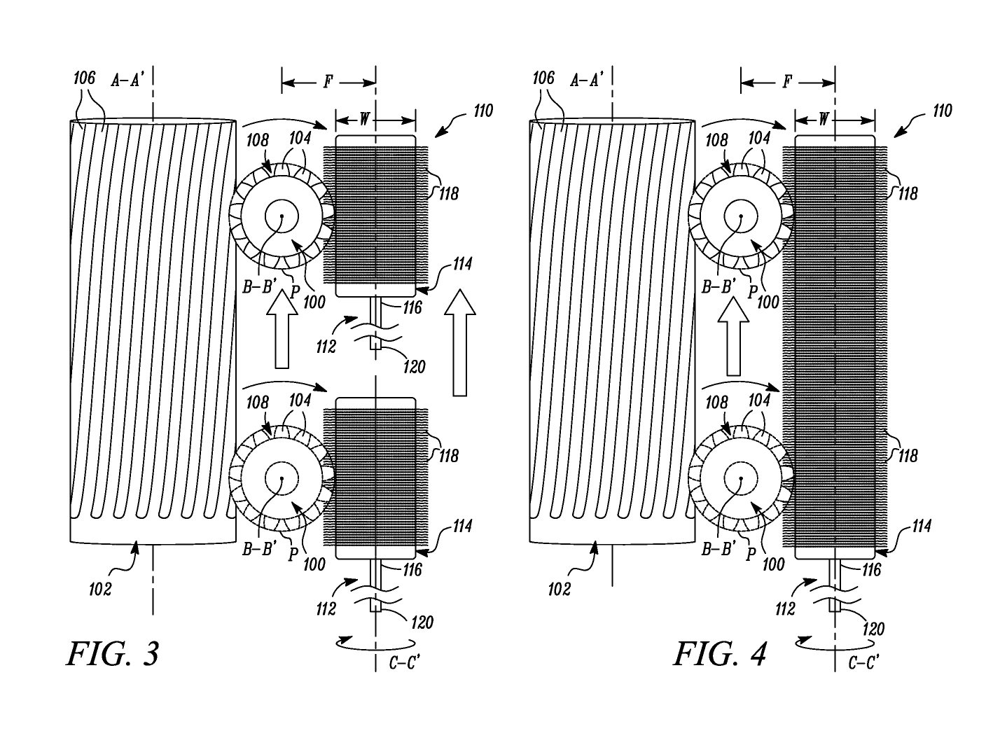

In an embodiment as shown in FIG. 3, the brush wheel 114 is configured to have a cylindrical shape and is sized significantly smaller than a size of the gear 102. Further, the brush wheel 114 is of a size comparable with or similar to that of the rotating hob 100 i.e., a width/diameter W of the brush wheel 114 measured across the longitudinal axis C-C′ of the brush wheel 114 is comparable with or similar to a length L of the hob 100 measured along the longitudinal axis B-B′ of the hob 100 (See length L of hob 100 in FIG. 1). In this embodiment, the brush wheel 114 may be configured to travel synchronously (i.e., together or at the same speed as the hob 100) with the hob 100 when the hob 100 undergoes translatory motion alongside the gear 102. The synchronous travel of the brush wheel 114 can be accomplished by using suitable mechanisms known to persons having ordinary skill in the art, with or without connection to the drive mechanism 122 and/or the prime mover 124 (shown in FIG. 2).

However, in an alternative embodiment as shown in FIG. 4, the brush wheel 114 can be of a size larger than that of the hob 100 i.e., a width/diameter W of the brush wheel 114 measured across the longitudinal axis C-C′ of the brush wheel 114 can be greater than a length L of the hob 100 measured along the longitudinal axis B-B′ of the hob 100 (See length L of hob 100 in FIG. 1). Therefore, in the embodiment of FIG. 4, the brush wheel 114 can beneficially remain stationary while the hob 100 undergoes translatory motion along an axis parallel to the longitudinal axis A-A′ of the gear 102. In this manner, the bristles 118 on the brush wheel 114 can remove any waste material deposited in the flutes 108 of the hob 100 as the hob 100 travels alongside the gear 102.

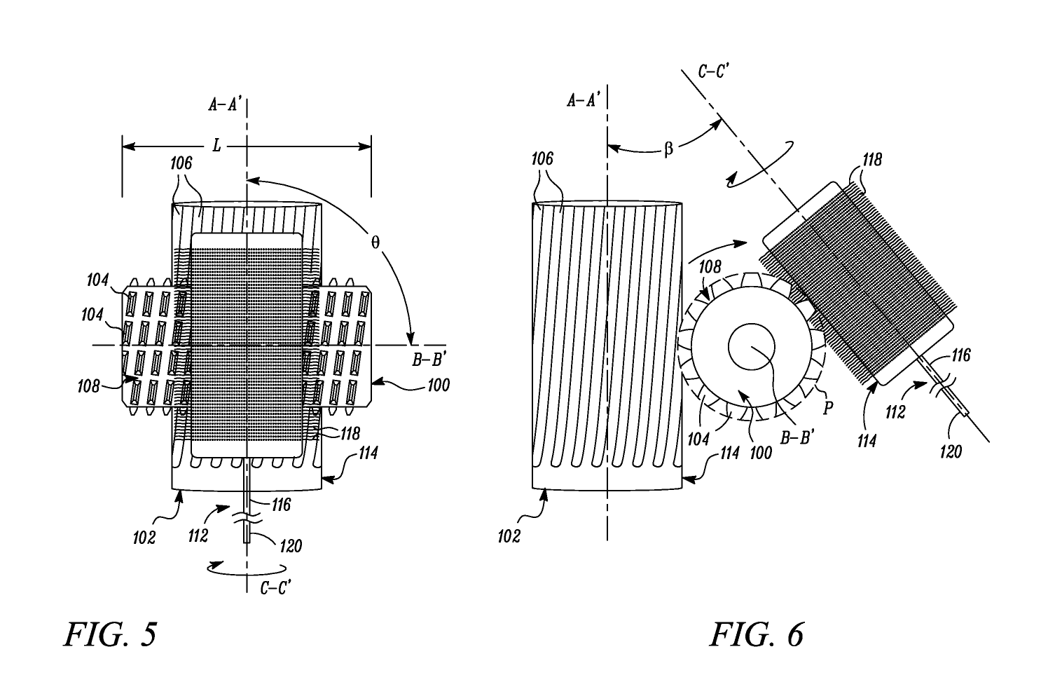

FIGS. 5 and 6 illustrate front and side views of an exemplary arrangement of a cylindrical brush wheel 114 in relation to the rotating hob 100, in accordance with another embodiment of the present disclosure. As shown in FIG. 5, the longitudinal axis of the cylindrical brush wheel 114 may be disposed normal i.e., at 90 degrees to the longitudinal axis B-B′ of the hob 100. However, as best seen in the side view of FIG. 6, the longitudinal axis of the cylindrical brush wheel 114 is disposed at an angle β, for e.g., about 60 degrees to the longitudinal axis A-A′ of the gear 102.

When the flutes 108 of the hob 100 are in substantial misalignment with a direction in which a force of gravity acts, then an arrangement (i.e. of the brush wheel 114 in relation to the hob 100 and the gear 102) such as that disclosed in FIGS. 5 and 6, can be beneficially implemented for removing any waste material from the flutes 108 of the hob 100. However, it should be noted that notwithstanding any particular advantage disclosed in this document, the relative arrangement of the brush wheel 114 with the hob 100 and the gear 102 disclosed from FIGS. 5 and 6 can be used to meet other specific requirements of a machining application.

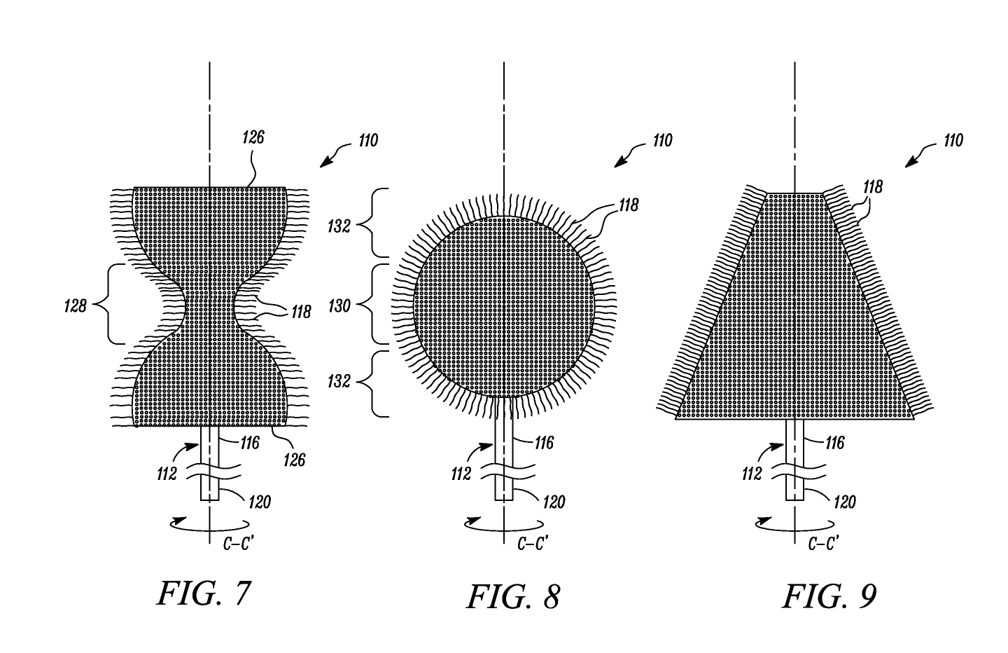

FIGS. 7-9 show front views of the apparatus 110 in accordance with different embodiments of the present disclosure. More specifically, FIG. 7 shows an hourglass-shaped profile of the brush wheel 114. In this embodiment, the brush wheel 114 can be configured to be broader at ends 126 than at a centre region 128. FIG. 8 shows a rounded profile of the brush wheel 114 so as to define a broader centre region 130 and a narrower pair of end regions 132. FIG. 9 shows a bell-shaped profile of the brush wheel 114 so as to define a taper in the shape of the brush wheel 114.

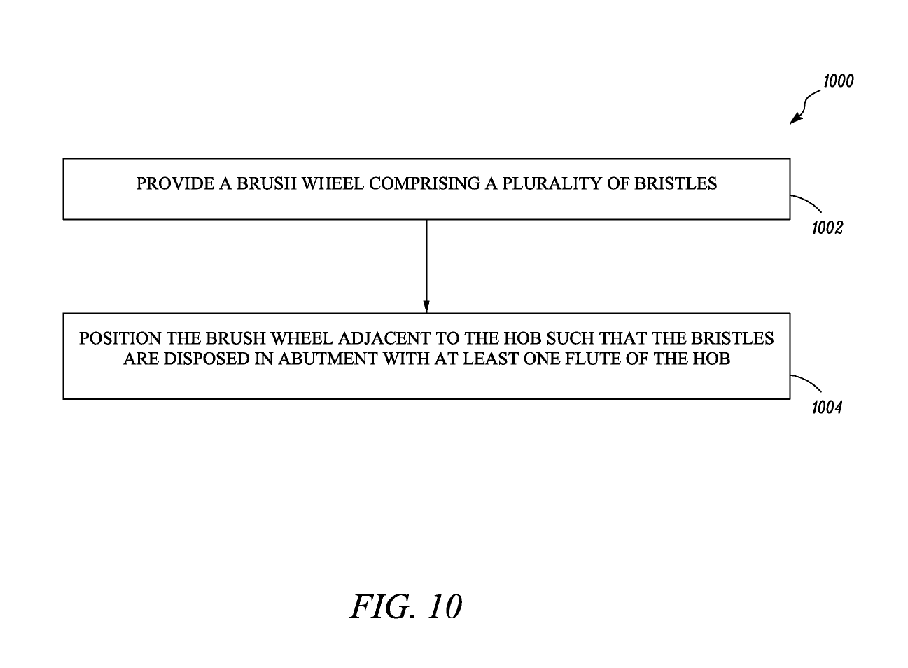

FIG. 10 illustrates a method of removing waste materials from flutes 108 of the hob 100, in accordance with an embodiment of the present disclosure. At step 1002, the method 1000 includes providing the brush wheel 114 having multiple bristles 118. At step 1004, the method includes positioning the brush wheel 114 adjacent to the hob 100 such that the bristles 118 are disposed in abutment with at least one flute of the hob 100.

In an embodiment, the method 1000 could include employing a helical profile of the brush wheel 114 (as shown in FIG. 2). In another embodiment, the method 1000 could include employing a circular profile of the brush wheel 114. In another embodiment, the method 1000 could include employing a cylindrical profile of the brush wheel 114 (as shown in FIGS. 3-5). In another embodiment, the method 1000 could include employing a brush wheel 114 whose profile is hourglass-shaped (as shown in FIG. 7). In another embodiment, the method 1000 could include employing a rounded profile of the brush wheel 114 (as shown in FIG. 8). In an alternative embodiment, the method 1000 could include employing a brush wheel 114 whose profile is bell-shaped (as shown in FIG. 9).

Optionally or additionally, the method could include providing the elongated handle 112. The first end 116 of the handle 112 can be configured to support the brush wheel 114 thereon while the second end 120 of the handle 112 can be beneficially configured to rotatably connect with the drive mechanism 122 associated with the hob 100 (See FIG. 2).

In another embodiment, the method could include configuring the brush wheel 114 to travel along the length L of the hob 100 in an axis parallel to the longitudinal axis B-B′ of the hob 100. However, if the width/diameter W of the brush wheel 114 is similar to or comparable with the length L of the hob 100, the method could additionally include configuring the brush wheel 114 to travel synchronously with the hob 100 when the hob 100 undergoes translatory motion alongside the gear 102.

Various embodiments disclosed herein are to be taken in the illustrative and explanatory sense, and should in no way be construed as limiting of the present disclosure. All directional references (e.g., axial, radial, above, below, upper, lower, top, bottom, vertical, horizontal, inward, outward, upward, downward, left, right, leftward, rightward, L.H.S, R.H.S, clockwise, and counter-clockwise) are only used for identification purposes to aid the reader's understanding of the present disclosure, and may not create limitations, particularly as to the position, orientation, or use of the devices and/or methods disclosed herein. Joinder references (e.g., attached, affixed, coupled, engaged, connected, and the like) are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

Embodiments of the present disclosure have applicability for implementation and use in removing waste material from flutes of a rotating hob during operation.

Typically, when forming gears from a metal blank using a hob, it has been seen that one or more flutes present in the hob can get deposited with waste material such as, but not limited to, metal chips. The waste material can then get trapped between the metal blank and the hob. As the hob undergoes subsequent motion in cutting the metal blank and forming the gear, the trapped waste material can potentially alter the effective cutting depths defined in the hob. The deposited and/or trapped waste material can therefore; decrease an overall quality and finish of the gear produced using the hob.

With use of embodiments disclosed herein, manufacturers of gears can easily remove the deposited waste material for e.g., the metal chips from the flutes of the hob. Moreover, as removal of the waste material from the flutes of the hob is substantially concurrent with rotation of the hob, ‘cleaned’ flutes, i.e., a hob devoid of any deposited waste material thereon can be presented in subsequent motion of the hob for accomplishing the cutting of the gear. In this manner, the hob can be made to produce gears with an improved quality and finish. Use of embodiments disclosed herein can therefore help manufacturers to offset costs previously incurred with performing rework of the gears. Moreover, implementation of embodiments disclosed herein may allow manufacturers to save time and effort that was typically associated with performing rework on gears from use of previously known and/or conventional manufacturing techniques.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An apparatus for removing waste material from flutes of a rotating hob when producing gears, the apparatus comprising:
an elongated handle disposed alongside the hob; and
a brush wheel disposed at a first end of the handle, the brush wheel comprising a plurality of bristles disposed in abutment with at least one flute of the hob.

2. The apparatus of claim 1, wherein the brush wheel is stationary with respect to the rotating hob.

3. The apparatus of claim 1, wherein the brush wheel is rotatable with respect to the rotating hob.

4. The apparatus of claim 1, wherein the brush wheel is configured to rotate synchronously with the hob.

5. The apparatus of claim 1, wherein the elongated handle is stationary with respect to the rotating hob so as to cause the brush wheel to remain stationary with respect to the rotating hob.

6. The apparatus of claim 1, wherein a profile of the brush wheel is at least one of: cylindrical, circular, helical, rounded, bell-shaped, and hourglass-shaped.

7. The apparatus of claim 1, wherein the elongated handle includes a second end configured to rotatably connect with a drive mechanism associated with the hob.

8. The apparatus of claim 1 further comprising a prime mover coupled with a second end of the elongated handle, the prime mover configured to operatively rotate the elongated handle and the brush wheel with respect to the rotating hob.

9. The apparatus of claim 1, wherein a longitudinal axis of the brush is disposed at an angle of about 0 to 90 degrees with respect to a longitudinal axis of the hob.

10. The apparatus of claim 1, wherein a distance between a longitudinal axis of the brush wheel is adjustable with respect to a longitudinal axis of the hob.

11. The apparatus of claim 1, wherein the bristles of the brush wheel are made from at least one of plastic, metal, and fabric.

12. The apparatus of claim 1, wherein a length of the brush wheel measured along a longitudinal axis of the brush wheel is less than a length of the hob measured along a longitudinal axis of the hob.

13. The apparatus of claim 12, wherein the brush wheel is configured to travel along the length of the hob in an axis parallel to the longitudinal axis of the hob.

14. The apparatus of claim 1, wherein the brush wheel is configured to travel synchronously with the hob when the hob undergoes translatory motion.

15. A method of removing waste material from flutes of a rotating hob when producing gears, the method comprising:
providing a brush wheel comprising a plurality of bristles;
positioning the brush wheel adjacent to the hob such that the bristles are disposed in abutment with at least one flute of the hob.

16. The method of claim 15 further comprising performing at least one of:
maintaining the brush wheel stationary with relation to the rotating hob; and
rotating the brush wheel against the rotating hob.

17. The method of claim 15, wherein a profile of the brush wheel employed in removing the waste material is at least one of: cylindrical, circular, helical, rounded, bell-shaped, and hourglass-shaped.

18. The method of claim 15 further comprising providing an elongated handle having a first end and a second end, wherein the first end is configured to support the brush wheel thereon, and wherein the second end is configured to rotatably connect with a drive mechanism associated with the hob.

19. The method of claim 15 further comprising configuring the brush wheel to travel synchronously with the hob when the hob undergoes translatory motion.
